(19) United States
(12) Patent Application Publication
(10) Pub. No.: US 2021/0065504 A1
(43) Pub. Date: Mar. 4, 2021

(54) MULTI-GATE SELECTION FEATURE FOR A BONUS GAME AND HYBRID CREDIT/BET MULTIPLIER CONFIGURATION

(71) Applicant: Aristocrat Technologies Australia Pty Limited, North Ryde (AU)

(72) Inventors: Scott Delekta, Las Vegas, NV (US); Allon Englman, Las Vegas, NV (US)

(73) Assignee: Aristocrat Technologies Australia Pty Limited, North Ryde (AU)

(21) Appl. No.: 16/581,667

(22) Filed: Sep. 24, 2019

Related U.S. Application Data
(60) Provisional application No. 62/894,848, filed on Sep. 1, 2019.

(51) Int. Cl. G07F 17/32; G07F 17/34

(52) U.S. Cl. CPC G07F 17/3244; G07F 17/3267; G07F 17/3213; G07F 17/3262; G07F 17/34

(57) ABSTRACT

In certain embodiments, an outcome for a base game is determined; based on the outcome, a bonus feature is initiated, wherein the bonus feature includes two or more bonus feature gates in which a user is offered two or more selections that modify the bonus feature based on a combination of the selections; a random outcome from a random generator is generated; and, based on the random outcome, a determination is made as to whether to trigger a secondary feature within the bonus feature, wherein a hit rate of the secondary feature is modified based on the combination of the selections.

### CROSS-REFERENCE TO RELATED APPLICATIONS

This application claims priority to U.S. Provisional Application No. 62/894,848 entitled “MULTI-GATE SELECTION FEATURE FOR A BONUS GAME AND HYBRID CREDIT/BET MULTIPLIER CONFIGURATION” and filed on Sep. 1, 2019, which is hereby incorporated herein by reference in its entirety.

### TECHNICAL FIELD

This application concerns electronic gaming machines (“EGMs”), and in particular to a feature-control mechanism having multiple stages for selecting and awarding one or more game sub-features and outcomes from those sub-features.

### BACKGROUND

EGMs provide a variety of wagering games such as slot games, video poker games, video blackjack games, roulette games, video bingo games, keno games and other types of games, which are frequently offered at casinos and other locations for use by players. Play on an EGM typically involves a player establishing a credit balance by inputting money, or another form of monetary credit, and placing a wager (from the credit balance) on one or more outcomes of an instance (or single play) of a primary or base game. In some cases, a player may qualify for a special mode of the base game, a secondary game (which refers to a secondary feature, as any outcome will be awarded to a player as part of a single game instance), or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

A “slot” type game is often presented to a player in the form of various symbols arrayed in a row-by-column grid (matrix). Specific matching combinations of symbols along predetermined paths (or “pay lines”) through the matrix indicate the outcome of the game. The display typically highlights winning combinations/outcomes for ready identification by the player. Matching combinations and their corresponding awards are usually shown in a “pay table,” which is available to the player for reference. Often, the player may vary his/her wager to include differing numbers of pay lines and/or the amount bet on each line. By varying the wager, the player may sometimes alter the frequency or number of winning combinations, frequency or number of secondary games, and/or the amount awarded.

Typically, a game uses a random number generator (“RNG”) to randomly determine the outcome of the game. A game is designed to return a certain percentage of the amount wagered back to a player over the course of many plays or instances of the game, which is generally referred to as return to player (“RTP”). The RTP and randomness of the RNG ensure the fairness of games and are highly regulated. For example, upon initiation of play, an RNG may randomly determine a game outcome, and symbols are selected which correspond to that outcome. Notably, some games may include an element of skill on the part of the player and are therefore not entirely random.

EGMs depend on usability to enhance the user experience and extend user time on the EGMs (in this disclosure, the terms “player” and “user” are used interchangeably). Although previous EGMs include various UI features, and backend operations associated with the UI features, that improve usability and enhance the user experience, there is room for further improvement to EGMs.

### SUMMARY

In summary, the detailed description presents innovations for a feature-control mechanism having multiple stages for selecting and awarding one or more game sub-features and outcomes from those sub-features.

The innovations can be implemented as part of a method, as part of an electronic gaming device such as an EGM or electronic gaming server, or as part of non-transitory computer-readable media storing computer-executable instructions for causing one or more processors in a computer system to perform the method. The various innovations can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

In certain embodiments, an outcome for a base game is determined; based on the outcome, a bonus feature is initiated, wherein the bonus feature includes two or more bonus feature gates in which a user is offered two or more selections that modify the bonus feature based on a combination of the selections; a random outcome from a random generator is generated; and, based on the random outcome, a determination is made as to whether to trigger a secondary feature within the bonus feature, wherein a hit rate of the secondary feature is modified based on the combination of the selections. In some implementations, one or more of the paytable, number of reels, size of the reels, or reel strips of the bonus feature are modified based on the combination of the selections. In further implementations, at least two of the bonus features as modified by the combination of the selections provide a constant or substantially constant return to player (“RTP”). In certain implementations, one of the two or more bonus feature gates presents the user a choice of two or more different reel sizes. In some implementations, one of the two or more bonus feature gates presents the user a choice of a multiplier range. In further implementations, a multiplier applied during the bonus feature is randomly selected from a selected multiplier range. In further implementations, a first of the bonus feature gates presents the user a choice of multiple different ranges of a first bonus feature characteristic, and, in a second of the bonus feature gates presents the user a choice of multiple different ranges of a second bonus feature characteristic, the multiple different ranges of the second bonus feature characteristics being dependent on and varied by the user's selection from the first of the bonus feature gates. In some implementations, each of the multiple different ranges of the second bonus feature characteristic are associated with a respective one of the first bonus feature characteristics from within the selected range of the first of the bonus feature gates. In certain implementations, the operations further comprise: causing the bonus feature to be performed based on the combination of the selections; and causing a jackpot bonus game feature to be performed based on a jackpot-winning result from the bonus feature as modified by the selections. In such implementations, a rate of achieving a progressive jackpot-winning result can be altered depending on the combination of the selections. In further implementations, an amount of a nonprogressive jackpot-winning result can be altered depending on the combination of the selections.

In a further embodiment, and as part of a base game or game feature in which a jackpot bonus game feature is available, a user is presented a first set of options for a number of different bet levels; and the user is simultaneously presented a second set of options for a number of different multipliers, each different multiplier resulting in a different multiplied value of bet credits, wherein, upon selection by the user of one of the first set of option, one or more of the different multipliers presented as part of the second set of options are modified. In certain implementations, a hit rate of one or more progressive awards and/or an amount of one or more nonprogressive awards offered in the jackpot bonus game feature is modified based on a combination of selections from the first set of options and the second set of options.

In some embodiments, an outcome for a base game is determined; and, based on the outcome, one of multiple game control pathways that lead to award of a jackpot bonus game feature is initiated. In some implementations, one of the multiple game control pathways includes two or more bonus game feature gates. In certain implementations, in at least one of the bonus game feature gates, the user can select one or more of a reel strip size, a number of free spins, or a multiplier. In particular implementations, in at least one of the bonus game feature gates, the user can select one or more of a range of reel strip sizes, a range of a number of free spins, or a range of a multiplier. In some implementations, a first of the bonus feature gates presents the user a choice of multiple different ranges of a first bonus feature characteristic, and a second of the bonus feature gates presents the user a choice of multiple different ranges of a second bonus feature characteristic, the multiple different ranges of the second bonus feature characteristics being dependent on and varied by the user's selection from the first of the bonus feature gates. In some implementations, selections from the two or more bonus game feature gates cause the bonus feature to be modified to provide a constant or substantially constant return to player (“RTP”). In certain implementations, selections from the two or more bonus game feature gates cause the bonus feature to be modified to provide different rates for awarding a jackpot feature. In some implementations, selections from the two or more bonus feature gates cause the bonus feature to be modified to provide a constant or substantially constant return to player (“RTP”) and one of the two or more bonus feature gates presents the user a choice of a multiplier range, and a multiplier applied during the bonus feature is randomly selected from a selected multiplier range.

### BRIEF DESCRIPTION OF THE DRAWINGS

The following drawings illustrate some features of the disclosed innovations. The drawings are not necessarily drawn to scale.

FIG. 1 is a perspective diagram of example EGMs according to some embodiments.

FIG. 2 is a block diagram illustrating an example of a networked EGM according to some embodiments.

FIG. 3 is a block diagram illustrating a example of a networked EGM according to some embodiments.

FIG. 4 is a flowchart illustrating an example technique for performing an embodiment of the disclosed technology.

FIGS. 5-16 are example screen shots showing aspects of the disclosed technology.

FIG. 17-20 are further flowcharts illustrating example techniques for performing embodiments of the disclosed technology.

### DETAILED DESCRIPTION

### I. Introduction

### I.A. Overview

The disclosed technology is directed to several game features. For example, one game feature involves a multi-gate selection feature that allows a user to choose his/her reel size and win multiplier after triggering a free spin bonus feature (which, depending on the implementation, can be any bonus feature). Based on the player's selection, the game selects a corresponding weighted table based on the multi-gate selection to determine a probability that a secondary bonus feature (e.g., a jackpot feature) activates. For each of the gate selection options, the weighted table is setup such that the RTP is the same or about the same even though the selected winning multiplier, number of free spins, and reel size vary. A second example game feature comprises a hybrid bet/multiplier feature in which a user/player can select a bet amount from an available set of options and then independently select a multiplier amount. In order to maintain a desired RTP, the particular combination of selections can adjust the hit rate of one or more progressive prizes and/or the size of a nonprogressive award. In particular implementations, the second example game feature allows a player to bet from 38-88 credits and also set a bet multiplier (e.g., 1×, 2×, 3×, 5×, 8×, and 10×). In this example, the credit selection from 38 credits to 88 credits can change the rate the jackpot feature will hit. Changing the bet multiplier causes certain nonprogressive awards in the secondary bonus feature, such as MINI and MINOR jackpot awards, to scale accordingly.

The innovations can be implemented as part of a method, as part of an electronic gaming device such as an EGM or electronic gaming server configured to perform the method, or as part of non-transitory computer-readable media storing computer-executable instructions for causing one or more processors in a computer system to perform the method. The various innovations can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### I.B. General Considerations

The detailed description presents innovations in electronic gaming machines (“EGMs”). Various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique/tool does not solve all such problems. It is to be understood that other examples may be utilized and that structural, logical, software, hardware, and electrical changes may be made without departing from the scope of the disclosure. The following description is, therefore, not to be taken in a limited sense. Rather, the scope of the present disclosure is defined by the appended claims.

The disclosed technology is directed to several game features. For example, one game feature involves a multi-gate selection feature that allows a user to choose his/her reel size and win multiplier after triggering a free spin bonus feature (which, depending on the implementation, can be any bonus feature). Based on the player's selection, the game selects a corresponding weighted table based on the multi-gate selection to determine a probability that a secondary bonus feature (e.g., a jackpot feature) activates. For each of the gate selection options, the weighted table is setup such that the RTP is the same or about the same even though the selected winning multiplier, number of free spins, and reel size vary. The second game feature allows a player to bet up from 38-88 credits and also set a bet multiplier (e.g., 1×, 2×, 3×, 5×, 8×, and 10×). The credit selection from 58 credits to 88 credits change the rate the jackpot feature will hit while changing the bet multiplier scales the certain awards in the secondary bonus feature (e.g., MINI and MINOR jackpot awards).

### II. Example Electronic Gaming Servers and Electronic Gaming Machines

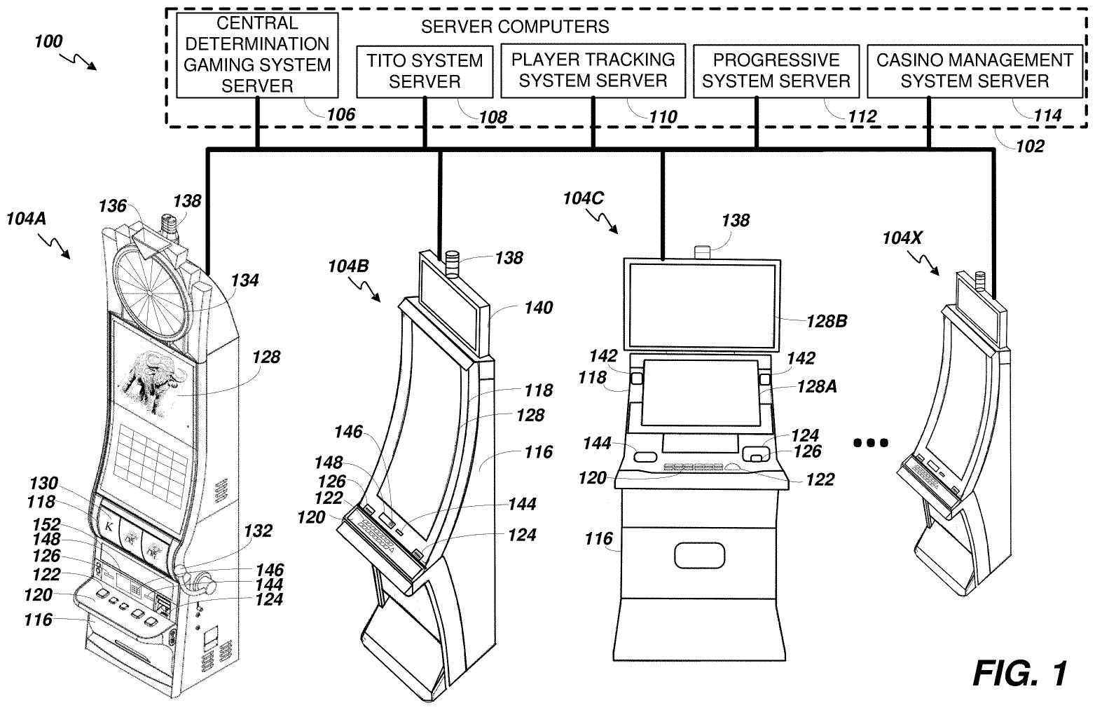

FIG. 1 illustrates several different models of EGMs which may be networked to various gaming-related servers. Shown is a system 100 in a gaming environment including one or more server computers 102 (e.g., slot servers of a casino) that are in communication, via a communications network, with one or more gaming devices 104A-104X that have communication interfaces with the network. The server computers 102 and/or gaming devices 104A-104X can implement one or more aspects of the present disclosure.

The gaming devices 104A-104X may be EGMs such as slot machines, video poker machines, bingo machines, etc. The gaming devices 104A-104X may alternatively be portable and/or remote gaming devices such as, but not limited to, a smartphone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (“RF”) (e.g., wireless fidelity (WiFi®) and Bluetooth®), cable TV, satellite links and the like.

In some embodiments, server computers 102 may not be necessary and/or preferred. For example, in one or more embodiments, a stand-alone gaming device such as gaming device 104A, gaming device 104B or any of the other gaming devices 104C-104X can implement one or more aspects of the present disclosure. In this case, functions normally performed by a server computer or data normally stored on a server computer may instead be performed by or stored on a gaming device. The stand-alone gaming device may be in communication with one or more other gaming devices (but not a server computer). However, it is typical to find multiple EGMs connected to networks implemented with one or more of the different server computers 102 described herein.

### II.A. Example Server Computers

Server computers 102 can include one or more servers that combine to form a casino management system, which manages one or more gaming devices 104A-X. Each of the servers includes at least one processor, memory, and a network interface, which enables communication over one or more networks between the server computers 102 and the gaming devices 104A-X. In general, the casino management system is configured to receive gaming data from the gaming devices 104A-X as the gaming devices 104A-X conduct rounds of play of one or more wagering games.

As shown in FIG. 1, the server computers 102 may include a central determination gaming system server 106 (also called a gaming server), a ticket-in-ticket-out (“TITO”) system server 108, a player tracking system server 110, a progressive system server 112, and/or a casino management system server 114. Gaming devices 104A-104X may include features to enable operation of any or all server computers 102 for use by the player and/or operator (e.g., the casino, resort, gaming establishment, tavern, pub, etc.). For example, game outcomes may be generated on a central determination gaming system server 106 and then transmitted over a network to any of a group of remote terminals or remote gaming devices 104A-104X that utilize the game outcomes and display the results to the players.

FIG. 1 shows different servers that perform different sets of functions. Alternatively, one or more of the different servers shown in FIG. 1 can be combined.

### II.B. Example Gaming Devices

Still referring to FIG. 1, the gaming devices 104A-C illustrated are specific exemplary embodiments of EGMs, and the same or similar elements shown in gaming devices 104A-C may be included in any gaming device 104X. More generally, an EGM may be any type of gaming machine and may include, without limitation, different structures than those shown in FIG. 1. A gaming device may use specially-configured computer hardware that implements game functionality, or a gaming device may use general-purpose computer hardware that has been programmed to implement game functionality. For example, an EGM can be implemented using a personal computer, tablet computer, smartphone, personal digital assistant, or any other computing device.

Gaming device 104A is often of a cabinet construction which may be aligned in rows or banks of similar devices for placement and operation on a casino floor. The gaming device 104A often includes a main door which provides access to the interior of the cabinet 116. Gaming device 104A typically includes a button area or button deck 120 accessible by a player that is configured with input switches or buttons 122, an access channel for a bill validator 124, and/or an access channel for a ticket-out printer 126. The input switches or buttons 122, along with other input devices, provide at least part of a player interface through which a player controls operation of a game. For example, buttons 122 may be used to start play of a primary game or secondary game. Alternatively, instead of having separate buttons that can be actuated physically, one or more of the buttons 122 can be presented on a touchscreen.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game.

In many configurations, the gaming machine 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube (“CRT”), or other conventional electronically controlled video monitor. Alternatively, the main display 128 can be a touchscreen display. The main display 128 is an interface component used to play a game on the gaming device 104A.

In some embodiments, the bill validator 124 may also function as a “ticket-in” reader that allows the player to use a casino issued credit ticket to load credits onto the gaming device 104A (e.g., in a cashless ticket (TITO) system). In such cashless embodiments, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming machine 104A can have hardware meters for purposes including ensuring regulatory compliance and monitoring the player credit balance. In addition, there can be additional meters that record the total amount of money wagered on the gaming machine, total amount of money deposited, total amount of money withdrawn, total amount of winnings on gaming device 104A.

In some embodiments, a player tracking card reader 144, a transceiver for wireless communication with a mobile device (e.g., a player's smartphone), a keypad 146, and/or an illuminated display 148 for reading, receiving, entering, and/or displaying player tracking information is provided in EGM 104A. In such embodiments, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152, which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116, which may be used to initiate game play. In general, a “handle pull” or “spin” of a game may refer to a single play at a gaming device, whether or not a handle is involved in the play, and whether or not a handle is even included in the gaming device. Thus, a play can be initiated by a press of a physical or virtual button, or via another activation mechanism.

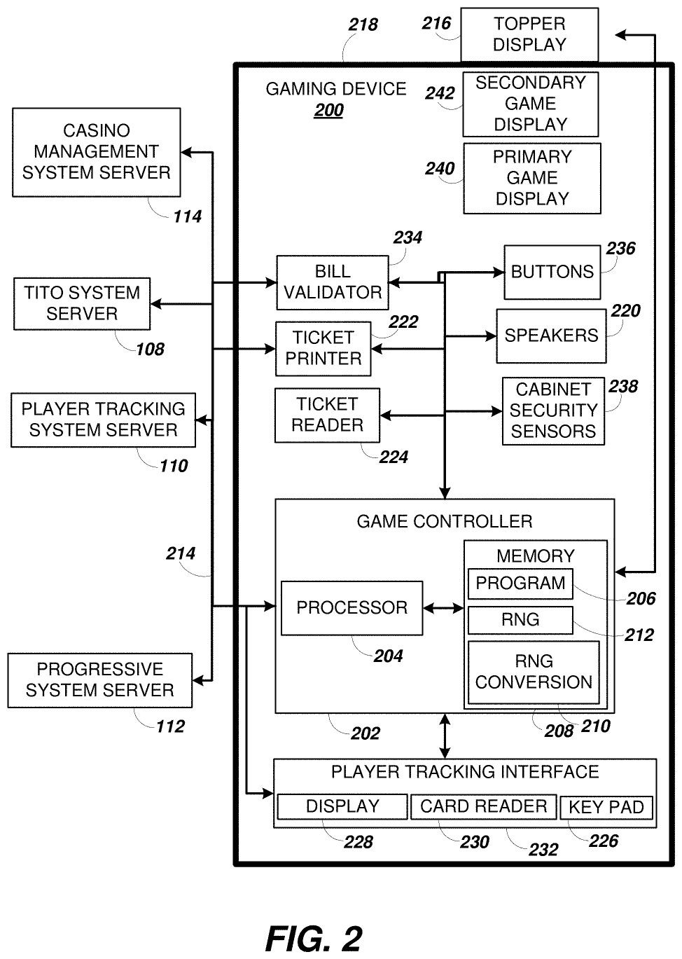

Many or all the above described components can be controlled by circuitry (e.g., a gaming controller) housed inside the main cabinet 116 of the gaming device 104A, the details of which are shown in FIG. 2.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. The main display 128 is in a portrait orientation with curvature radius from top to bottom. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Where possible, reference numerals identifying similar features of the embodiments of gaming devices 104A and 104B are used to identify corresponding features of gaming device 104C.

Gaming device 104C does not include physical reels and instead shows game play functions on main display 128A and a secondary display 128B. Gaming device 104C includes a main display 128A that is in a landscape orientation. The main display 128A or secondary display 128B can be a high-resolution LCD, plasma, LED, OLED, or SED panel, Although not illustrated by the front view provided, the landscape display 128A may have a curvature radius from top to bottom, or alternatively from side to side. In some embodiments, display 128A is a flat panel display. Alternatively, the main display 128A can be a touchscreen display. Main display 128A is typically used for primary game play while secondary display 128B is typically used for bonus game play, to show game features or attraction activities while the game is not in play or any other information or media desired by the game designer or operator. The secondary display 128B may be in a landscape orientation with curvature radius from top to bottom, or may be flat. In some embodiments, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

### II.C. Example Components of Gaming Device

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1.

As shown in FIG. 2, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smartphone enabling player tracking. FIG. 2 also depicts utilizing a ticket printer 222 to print tickets for a TITO system server 108. Gaming device 200 may further include a bill validator 234, player-input buttons 236 for player input, and cabinet security sensors 238 to detect unauthorized opening of the cabinet 218, each coupled to and operable under the control of game controller 202. The game controller 202 may be a circuit (e.g., an electronic circuit board, a programmable computer chip, etc.) within a gaming device that, in addition to controlling other components, includes one or more processors that process game play instructions in accordance with game play rules, and outputs or generates game play outcomes to one or more displays.

The gaming device 200 includes several display screens, each coupled to and operable under the control of the game controller 202. A primary game display 240 acts as a main display 128, 128A as described with reference to FIG. 1. A secondary game display 242 acts as a secondary display 128B as described with reference to FIG. 1. The gaming device 200 can include a credit display that displays a player's current number of credits, cash, account balance, or the equivalent. The gaming device 200 can also include a bet display that displays a player's amount wagered. The credit display and/or bet display may be standalone displays, independent of the primary game display 240 and secondary game display 242. Alternatively, the credit display and/or bet display can be incorporated into the primary game display 240 or secondary game display 242. Any of the display screens can be implemented as a touchscreen, with an associated touchscreen controller. In this case, such display screens may be operated as input devices in addition to presenting information, to provide input game play decisions (e.g., actions on and selection of game presentation objects).

The games available for play on the gaming device 200 are controlled by a game controller 202. In general, the game controller 202 conducts a wagering game, generates gaming data (e.g., for wagers, game outcomes, payouts, player ratings, duration of play, and time between rounds of play), and, for each round of play of the wagering game, awards a payout or win amount according to a pay table. A base game can include a bonus game that the game controller 202 also conducts. The game controller 202 determines an outcome of the process and outputs an indication of the outcome of the process. For example, the game controller 202 determines whether any win conditions exist (on pay lines) and awards win amounts to the player. More generally, the game controller 202 can process game play instructions and generate outcomes as described below.

The game controller 202 includes one or more processors 204. Processor 204 represents a general-purpose processor, a specialized processor intended to perform certain functional tasks, or a combination thereof. As an example, processor 204 can be a central processing unit (“CPU”) that has one or more multi-core processing units and memory mediums (e.g., cache memory) that function as buffers and/or temporary storage for data. Alternatively, processor 204 can be a specialized processor, such as an application specific integrated circuit (“ASIC”), graphics processing unit (“GPU”), field-programmable gate array (“FPGA”), digital signal processor (“DSP”), or another type of hardware accelerator. In another example, processor 204 is a system on chip (“SoC”) that combines and integrates one or more general-purpose processors and/or one or more specialized processors. Although FIG. 2 illustrates that game controller 202 includes a single processor 204, game controller 202 is not limited to this representation and instead can include multiple processors 204 (e.g., two or more processors).

FIG. 2 illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (“RAM”), read-only memory (“ROM”), hard disk drives, solid-state drives, universal serial bus (“USB”) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (“SRAM”), dynamic random access memory (“DRAM”), magnetic random access memory (“MRAM”), and other such devices. Examples of ROM include a programmable read-only memory (“PROM”), an erasable programmable read-only memory (“EPROM”), an electrically erasable programmable read-only memory (“EEPROM”), or other like memory device. Even though FIG. 2 illustrates that game controller 202 includes a single memory 208, game controller 208 could include multiple memories 208 for storing program instructions and/or data.

Memory 208 can store one or more game programs 206 that provide program instructions and/or data for carrying out various embodiments (e.g., game mechanics) described herein. Stated another way, game program 206 represents an executable program stored in any portion or component of memory 208. In one or more embodiments, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchange with one or more remote gaming devices, such as a central determination gaming system server 106 (not shown in FIG. 2 but shown in FIG. 1). For purpose of this disclosure, the term “game instance” refers to a play or a round of a game that gaming device 200 presents (e.g., via a UI) to a player. Output for the game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a ROM) or from the central determination gaming system server 106 to memory 208.

When games are implemented in an online environment, at least a portion of the game software can be stored in a remote game server or in a cloud computing service. Game transactions such as adding money to the game (i.e., cash in) and withdrawing money from the game (i.e., cash out) are substituted by implementing electronic fund transfers. A player deposits money into his online gaming account via checks, debit cards, wire and the like. Once funded, the player can move a portion of the cash in his account into the game he wants to play. This process is referred to as account-based wagering. Account-based wagering is a convenient monetary transaction system for online and mobile wagering environments since the physical bill acceptor and ticket printer are not available. In addition to the accounting meters' separation, detection of the location where the wagering transaction take place is also performed in order to enforce local gaming regulations and properly calculate revenue, profit, and tax withholdings, for example. Thus, a remote gaming device can access a casino via a computer network and participate in a game of chance. The remote gaming device may be a PC, smartphone, or other computing device coupled to the Internet via a wired or wireless link (and, e.g., connecting to a casino management system via a virtual private network). The remote gaming device may be a terminal-based machine, where the actual game (including RNG and outcome determination) is hosted at a gaming server, with the terminal-based machine displaying results of the game via one or more display screens.

The game controller 202 can communicate over a network with one or more other gaming devices or other devices via a communication interface. The communication interface may operate as an input device (e.g., by receiving data from another device) and/or as an output device (e.g., by transmitting data to another device). The gaming device 200 can also include one or more communication ports that enable the game controller 202 to communicate with peripheral devices, external video sources, expansion buses, or display screens.

FIG. 2 depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming machine. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or selecting various items during a feature game). The player may make these selections using the player-input buttons 236, the primary game display 240 which may be a touchscreen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Some embodiments described herein represent improvements in the technical area of EGM software and provide new technology, in that they improve usability of EGMs by enhancing the user experience, extending player time on the EGMs, and maintaining the interest of current users in the EGMs.

Gaming devices such as gaming device 200 (as a generalized example of devices 104A-X) typically include special features and/or additional circuitry that differentiates them from general-purpose computers (e.g., desktop computers and laptops). Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness (e.g., that outcomes will be statistically independent, uniformly distributed over their range, unpredictable and pass statistical tests such as chi-square test, equi-distribution test, gap test, runs test, serial correlation test, etc.). Typically, gaming jurisdictions mandate that gaming devices 200 satisfy a minimum level of randomness without specifying how a gaming device 200 should achieve this level of randomness. To comply, FIG. 2 illustrates that gaming device 200 includes an RNG 212 that utilizes hardware and/or software to generate RNG outcomes that lack any pattern. The RNG 212 can be integrated into the game controller 202 or processor 204. The RNG operations are often specialized and non-generic in order to comply with regulatory and gaming requirements. For example, in a reel game, game program 206 can initiate multiple RNG calls to RNG 212 to generate RNG outcomes, where each RNG call and RNG outcome corresponds to an outcome for a reel. (Gaming regulations may require that each reel outcome be independent of each other reel outcome, such that no reel outcome depends on any other reel outcome.) In another example, gaming device 200 can be a Class II gaming device where RNG 212 generates RNG outcomes for creating Bingo cards. In one or more embodiments, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%).

A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2 illustrates that gaming device 200 includes an RNG conversion engine 210 that translates the RNG outcome from RNG 212 to a game outcome presented to a player. To meet a designated RTP, a game developer can setup the RNG conversion engine 210 to utilize one or more lookup tables (e.g., weighted tables) to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

As noted, gaming devices 200 are specially-configured computer systems and not merely general-purpose computers. For example, one difference between a gaming device 200 and common processor-based computer system is that gaming device 200 is designed to be a state-based system. In a state-based system, the system stores and maintains its current state in non-volatile memory, which can be implemented using battery-backed RAM, flash memory, a solid-state drive, or other persistent memory. Different functions of a game (e.g., bet, play, result, points in the graphical presentation, etc.) may be defined as a state. When a game moves from one state to another, data regarding the game state is stored in a custom non-volatile memory subsystem. In some cases, the gaming device 200 does not advance from a current state to a subsequent state until information that allows the current state to be reconstructed is stored. In the event of a power failure or other malfunction, the gaming device 200 will return to its current state when the power is restored by recovering state information from non-volatile memory. The restored state may include metering information and graphical information that was displayed on the gaming device 200 in the state prior to the malfunction. For example, if a player was shown an award for a game of chance and, before the award could be provided to the player, the power failed, the gaming device 200, upon the restoration of power, would return to the state where the award is indicated. More generally, the gaming device 200 records, in non-volatile memory, the values of game parameters assigned during play, such as variables determined by an RNG or internal counters. (A game parameter, in general, can be one or more variables whose values govern play at the gaming device and depend on a random selection process.) The value of a game parameter can be recorded periodically, in response to some event such as user input, or whenever the value of the game parameter changes. This way, the gaming device 200 can recover its state in case of a power failure or “tilt” event, allowing the gaming device 200 to reconstruct events that have taken place before the power failure or “tilt” event. In contrast, PCs are not state machines to the same extent, and a majority of data is usually lost when a malfunction occurs. This requirement affects the software and hardware design on a gaming device 200. Game history information regarding previous games played, such as an amount wagered, the outcome of the game and so forth, may also be stored in a non-volatile memory device.

Although FIGS. 1 and 2 illustrates specific embodiments of a gaming device (e.g., gaming devices 104A-104X and 200), the disclosure is not limited to those embodiments shown in FIGS. 1 and 2. For example, not all gaming devices suitable for implementing embodiments of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

Additionally, or alternatively, gaming devices 104A-104X and 200 can include credit transceivers that wirelessly communicate (e.g., Bluetooth or other near-field communication technology) with one or more mobile devices to perform credit transactions. As an example, bill validator 234 could contain or be coupled to the credit transceiver that output credits from and/or load credits onto the gaming device 104A by communicating with a player's smartphone (e.g., a digital wallet interface).

Gaming devices 104A-104X and 200 may also include other processors that are not separately shown. Using FIG. 2 as an example, gaming device 200 could include display controllers (not shown in FIG. 2) configured to receive video input signals or instructions to display images on game displays 240 and 242. Alternatively, such display controllers may be integrated into the game controller 202. The use and discussion of FIGS. 1 and 2 are examples to facilitate ease of description and explanation.

Those of skill in the art will appreciate that embodiments of the present disclosure could be implemented with more or fewer elements than are depicted in FIG. 2. The pictured example embodiments of a gaming device 200, as well as example gaming devices 104A-C, are merely a few examples from a wide range of possible gaming device designs on which embodiments of the present disclosure may be implemented. Depending on implementation and the type of processing desired, components of the gaming device 200 can be added, omitted, split into multiple components, combined with other components, and/or replaced with like components. In alternative embodiments, gaming devices with different components and/or other configurations of components perform one or more of the described techniques. Specific embodiments of gaming devices typically use a variation or supplemented version of the gaming device 200. The relationships shown between components within the gaming device 200 indicate general flows of information in the gaming device 200; other relationships are not shown for the sake of simplicity. In general, the game controller 202 can be implemented by software executable on a CPU, by software controlling special-purpose hardware, or by special-purpose hardware (e.g., in an ASIC).

### II.D. Example Game Processing Architecture

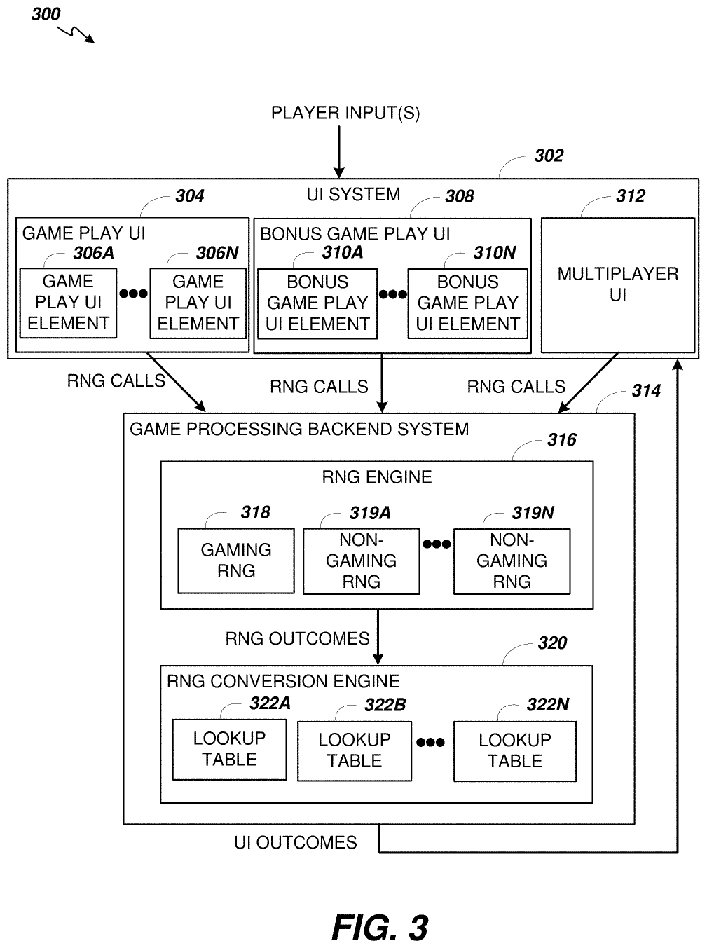

FIG. 3 illustrates, in block diagram form, an example game processing architecture 300 that implements a game processing pipeline for the play of a game in accordance with various embodiments described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes, based on the RNG outcomes, for the UI system 302 to use to control game play (e.g., a display to a player). The game processing architecture 300 can implement the game processing pipeline using a gaming device, such as one of the gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 306, where each UI type includes one or more mechanical UIs and/or graphical UIs (GUIs). In other words, the game play UI 304, bonus game play UI 308, and multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with in a base game. During a game instance of a base game, the game play UI elements 306A-306N (e.g., GUI elements depicting one or more reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more embodiments, at least some of the game play UI element 306A-306N are similar to the bonus game play UI elements 310A-310N. In other embodiments, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or present game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 can generate RNG calls to a game processing backend system 314. As an example, the UI system 302 can use one or more application programming interfaces (“APIs”) to generate the RNG calls. To process the RNG calls, the RNG engine 316 could utilize gaming RNG 318 and/or non-gaming RNGs 319A-319N. Gaming RNG 318 corresponds to RNG 212 shown in FIG. 2. As previously discussed with reference to FIG. 2, gaming RNG 318 often performs specialized and non-generic operations that comply with regulatory and/or game requirements. For example, because of regulation requirements, gaming RNG 318 can be a cryptographic random or pseudorandom number generator (“PRNG”) (e.g., Fortuna PRNG) that securely produces random numbers for one or more game features. To generate random numbers, gaming RNG 318 could collect random data from various sources of entropy, such as from an operating system (“OS”). Alternatively, non-gaming RNGs 319A-319N may not be cryptographically secure and/or be computational less expensive. Non-gaming RNGS 319A-319N can, thus, be used to generate outcomes for non-gaming purposes. As an example, non-gaming RNGs 319A-319N can generate random numbers for purposes such as generating random messages that appear on the gaming device.

The RNG conversion engine 320 processes each RNG outcome from RNG engine 316 and converts the RNG outcome to a UI outcome that is fed back to the UI system 302. With reference to FIG. 2, RNG conversion engine 320 corresponds to RNG conversion engine 210 used for game play. As previously described, RNG conversion engine 320 translates the RNG outcome from the RNG 212 to a game outcome presented to a player. For example, RNG conversion engine 320 utilizes one or more lookup tables 322A-322N (weighted tables) to regulate a prize payout amount for each RNG outcome and how often the gaming device pays out the derived prize payout amounts. In one example, the RNG conversion engine 320 could utilize one lookup table to map the RNG outcome to a game outcome displayed to a player and utilize a second lookup table as a pay table for determining the prize payout amount for each game outcome. In one example, the mapping from the RNG outcome to the game outcome can affect the level of volatility for the game, e.g., by regulating the frequency of occurrence of a game feature such as hitting certain prize payout amounts, triggering a bonus game or special mode, winning a progressive jackpot, etc. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to the updating the appropriate UI, the player may subsequently provide additional player inputs to initiate a subsequent game instance that progresses through the game processing pipeline.

In general, the example game processing architecture 300 shown in FIG. 3 can be used to process game play instructions and generate outcomes as described below. For example, in some example implementations, the example game processing architecture 300 implements a game processing pipeline for a process that performs any of the multi-gate features described below. In response to a start condition, the game play UI 304 (or bonus game play UI 308) makes one or more RNG calls to the game processing backend system 314. In response, the backend system 314 performs various operations. Using a gaming RNG 318, the RNG engine 316 generates one or more random numbers, which are passed to the RNG conversion engine 320. Using the gaming RNG 318, the RNG engine 316 determines more random numbers, which the RNG conversion engine 320 uses (along with one or more of the lookup tables 322A . . . 322N) to determine symbol stop positions for the reels. The backend system 314 can also determine the outcome of the process (e.g., calculating whether any win conditions exist on pay lines). Eventually, the game play UI 304 (or bonus game play UI 308) stops the spinning of the reels at the symbol stop positions returned for the respective reels. Finally, the game play UI 304 (or bonus game play UI 308) outputs an indication of the outcome of the process.

In certain embodiments, the determined sub-feature is activated and a resulting outcome is selected (e.g., using an RNG (such as gaming RNG 318) that applies a lookup table). Subsequently, a display of the determined result of the sub-feature is activated. A determination can then be made as to whether the sub-feature selected is a terminating event (or sub-feature), which indicates that the bonus feature is to be terminated, and a return to the base reel game (after awarding any bonus feature credits are awarded) is to be executed. If a terminating event (sub-feature) has not been selected, then the procedure continues where one or more modifications can be made to the primary game reels. The example game processing architecture 300 shown in FIG. 3 can be used process game play instructions and generate outcomes as described in Section III and is discussed in more detail below.

### III. Example Embodiments

### III.A. Example Multi-Gate Feature Embodiments

In certain disclosed embodiments, there are two ways that a jackpot feature can hit (although additional ways are also possible). In the described embodiment, the first method to trigger the jackpot feature is through a base game feature. In the base game feature, one or more WILD substitutes (although any selected symbol can be used) land on the base game reels. The one or more WILD substitutes trigger an RNG/lookup table operation (using, for example, gaming RNG 318 of FIG. 3) to determine whether to enter the jackpot feature. For example, when a WILD substitute lands on the base game reels, based on the RNG/lookup table (e.g., RNG 318 of FIG. 3), the user has a selected chance (e.g., a bonus rate, which can be any bonus rate to trigger the jackpot feature (e.g., a pick three jackpot feature)). In another example embodiment, the second method to trigger the jackpot feature is when a user is in a free game bonus feature (although any type of bonus feature can be used as a trigger).

Still further, in certain embodiments, the free game bonus feature is itself configured through a multi-gate process. For example, in particular embodiments, two gates are used to configure the free game bonus feature. In a particular implementation, shown in the attached figures, a reel height gate and a number of free spin gate (described in more detail below) are used to dynamically determine the rate for triggering the jackpot feature while in the free game bonus feature. In other embodiments, more than two gates can be used to configure the free game bonus feature.

Because the characteristics for triggering the jackpot are dictated by two (or more) gate selections by the user, the game, in some embodiments, compensates for the rate (RNG/lookup table operation) that the jackpot feature (e.g., a secondary bonus feature) hits while in the free spin bonus feature. No matter the option feature selected based on the multi-gate, all options have the same overall rate to hit the jackpot bonus feature. This in turn help ensures the game complies with regulatory requirements that any player selection made through the gating selection have substantially the same RTP.

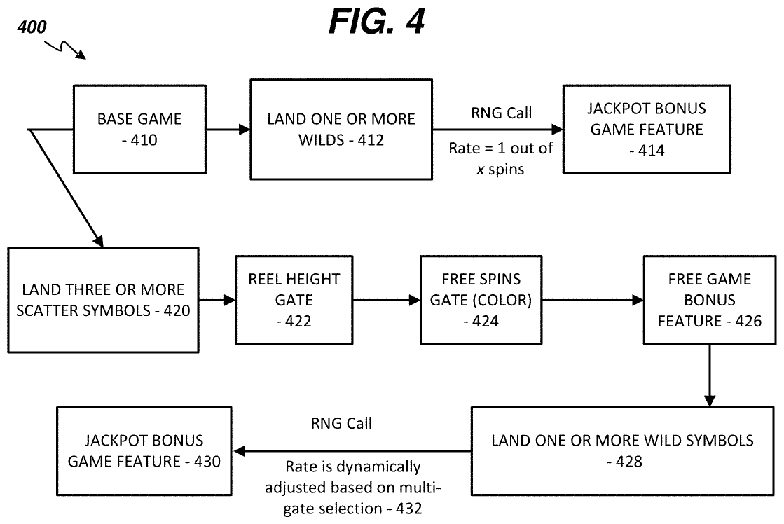

FIG. 4 is a flowchart 400 showing an example process flow for triggering the jackpot bonus game feature. In particular, the method of FIG. 4 can be performed by a game controller of a gaming device (e.g., game controller 202) or a server (e.g., central determination gaming system server 106) in communication with an EGM and/or other gaming device(s). Although the illustrated method is described in a particular, sequential order, it should be understood that this manner of description encompasses rearrangement. For example, operations described sequentially may in some cases be rearranged or performed concurrently.

In particular embodiments, the example manner in which the game triggers the jackpot bonus game feature is when one or more WILDs land. Whether a WILD lands is based on a first set of RNG calls to determine reel stop positions for all reels. Once a WILD lands, a separate/second RNG call is made to determine whether to trigger a jackpot feature.

Thus, because the second RNG call is based on a symbol landing on the reels, reel size and the number of free spins will affect the likelihood of triggering a second RNG call. In most (but not necessarily all) cases, when the game configuration has a large reel size and/or a large number of free spins, the chance of hitting the jackpot feature will increase. As a result, the hit rate (e.g., weights on the table) for the jackpot feature is desirably adjusted according to the reel size and the number of free spins.

At 410, a base game is initiated and an outcome is determined. In the example embodiment, if the outcome of the base game results in one or more WILD symbols (shown at 412), then a possibility for a jackpot bonus game is triggered. The determination can be made using an RNG call and/or one or more lookup tables that generates an approximate jackpot bonus trigger rate of 1 out of x, where x can be any desired integer value. If the trigger is achieved, then a jackpot bonus game feature is activated at 414. In general, operations 412 and 414 represent a first path to the jackpot bonus game feature.

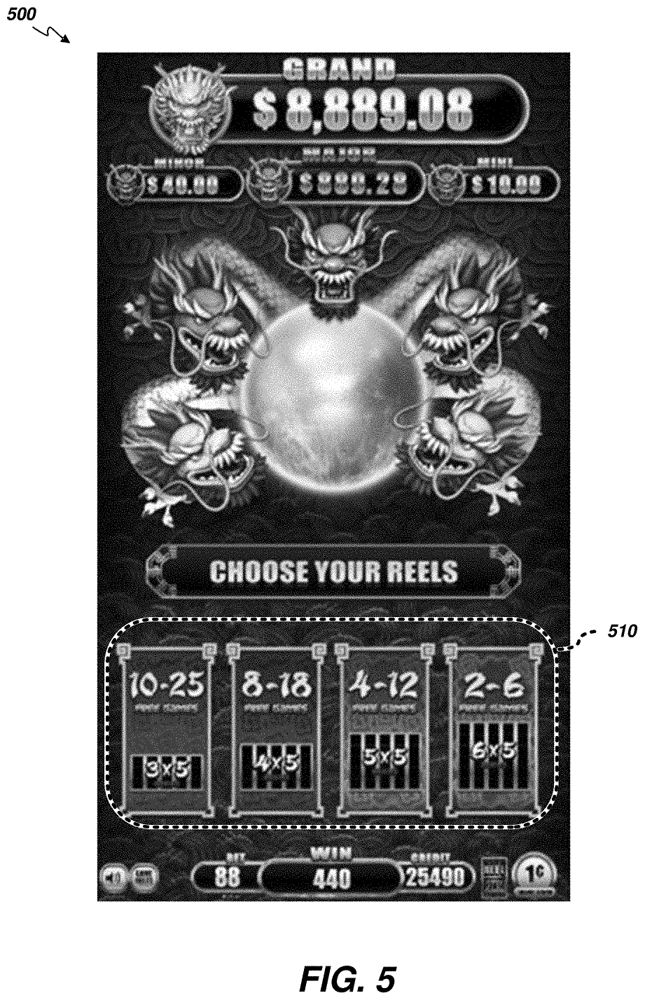

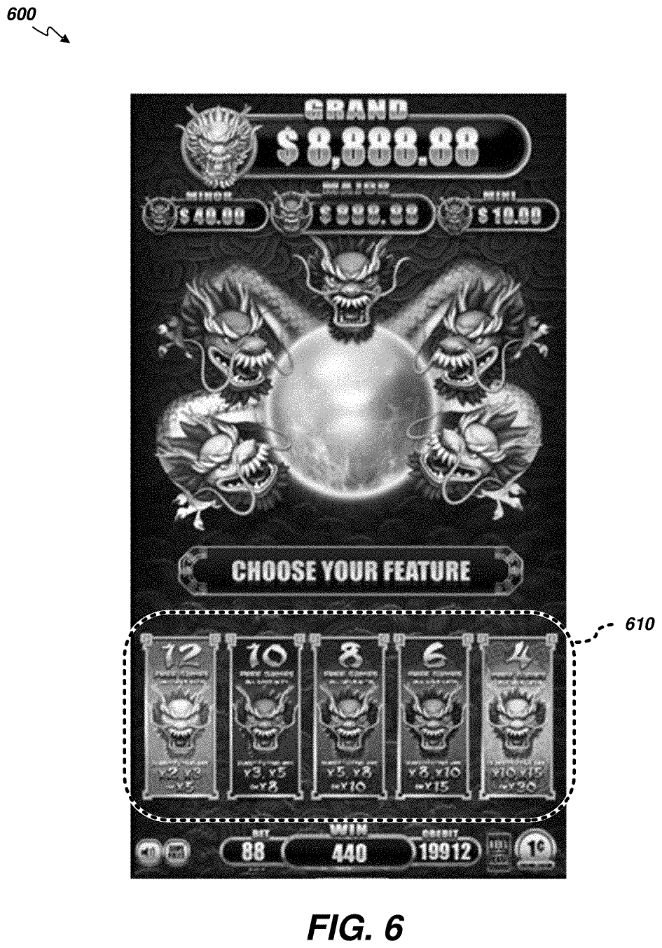

In the example embodiment, if the outcome of the base game results in one or more scatter symbols (e.g., 3 or more scatter symbols, as shown at 420), then two or more feature gates are initiated. In the illustrated embodiment, the multiple gates comprise a reel height gate (implemented at 422) and a gate that is used to select a number of free spins associated with a range of multipliers (implemented at 424). Still further, selections from the first gate can influence and cause a particular configuration of the second gate (e.g., alterations in the available selections (such as alterations in the available multipliers)). As an example, the first gate can provide a range of free spins (e.g., 4-12 free spins) that can be awarded at the second gate, which is discussed later in the disclosure with reference to FIGS. 5 and 6. Further, in certain examples and as illustrated, a selection of a particular number of free spins can invoke selection of a multiplier from a range of multipliers.

At 426, a free game bonus feature is activated. As explained herein, the two or more gates can be used to configure the free game bonus feature (e.g., in terms of one or more of reel strips, number of free games, etc.).

If one or more WILD symbols land (as shown at 428), then a possibility for a jackpot bonus game is triggered. The determination can be made using an RNG, which in the illustrated embodiment is dynamically adjusted based on the multi-gate selection (as shown at 432). The rate can be any of 1 to x, where x can be any integer value as determined by the game designer but, in this example, is dependent on the outcome of the selections from the multiple gates. If the trigger is achieved, then a jackpot bonus game feature is activated at 430.

In general, procedures 420-430 represent a second path to the jackpot bonus game feature. Further, and in accordance with particular embodiments of the disclosed technology, the overall hit rate of the jackpot bonus game via procedures 420-430 is configured to be constant (or substantially constant) so that the RTP of the game is not substantially altered by any particular selection made by the user during the multi-gate selection process (here, gates 412 and 424). For example, this can be accomplished through the dynamic adjustments made at 432, which may be in the form of altering the jackpot bonus game feature hit rate for any particular post-gates configuration.

FIGS. 5-6 are FIGS. 500 and 600 that illustrate the two gate features a user will see in certain embodiments after triggering the free spin bonus feature by landing multiple (e.g., 3) or more scatter symbols in the base game.

The first gate feature (shown in FIG. 5) is arranged according to the reel size. In certain embodiments, the smaller reel size, the greater number of games while the larger the reel size, the less number of games. As can be seen at 510, the user is offered a selection of reel sizes (e.g., 3×5, 4×5, 5×5, and 6×5) and a possible range of free games that may be selected for each reel size (e.g., 10-25, 8-18, 4-12, and 2-6). The second gate feature (shown in FIG. 6) is arranged according to the color of a game-themed symbol (here, and for the remainder of this disclosure, dragons, although the game-themed symbol can vary from implementation to implementation) In the illustrated embodiment, and as shown in 610, each dragon is associated with a number of free spins (e.g., 12, 10, 8, 6, 4) and a range of multipliers (e.g., (×2, ×3, ×5), (×3, ×5, ×8), (×5, ×8, ×10), (×10, ×15, ×30). It is to be understood that these example numbers are by way of example only and can be varied from implementation to implementation. After a player makes the selection, each time a player hits the play/spin button to spin the reels, the game application makes a separate RNG call and utilizes one or more specific lookup table to determine whether to enter a secondary feature (e.g., jackpot bonus feature. In one or more implementation, how the lookup table is weighted to determine when to trigger a secondary feature is based on the multi-gate selection parameter, such as the reel size and the number of free games awarded. In other implementations that utilize more than two gate selection features and/or other configure other game parameters besides reel size and the number of free games, the lookup table can be weighted in a variety of fashions.

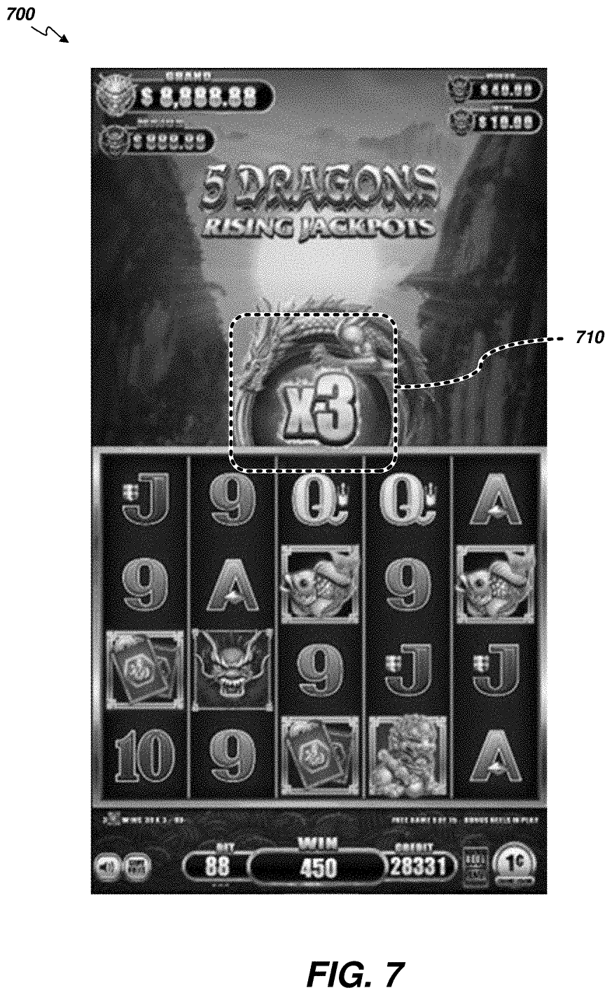

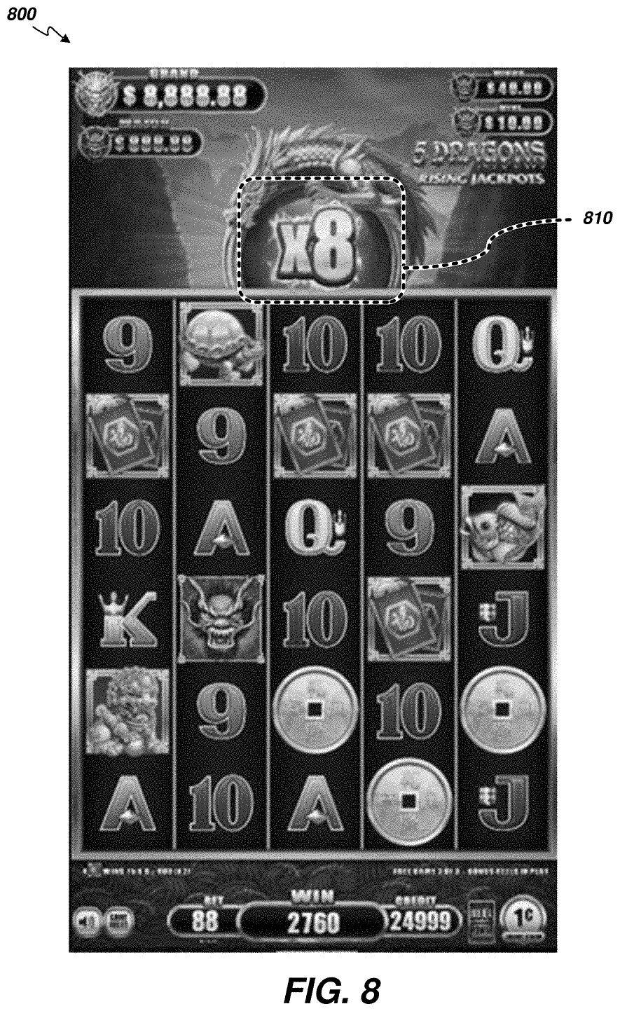

FIGS. 7-8 are FIGS. 700 and 800 of the free game bonus feature after finishing the multi-gate feature. In general, FIGS. 7 and 8 illustrate how the user selection from the first gate feature influences and configures the second gate feature. In more detail, and in this example embodiment, FIG. 7 shows the free game bonus feature where the user has selected the “red” dragon from FIG. 6 (the second from the left, and, in the illustrated embodiment, triggering a red game background) and a resulting multiplier of “×3” (shown at 710) was selected by an RNG. FIG. 8 shows the free game bonus feature where the user has selected the “blue” dragon from FIG. 6 (the fourth from the left, and, in the illustrated embodiment, triggering a blue game background) and a resulting multiplier of “×8” (shown at 810) was selected.

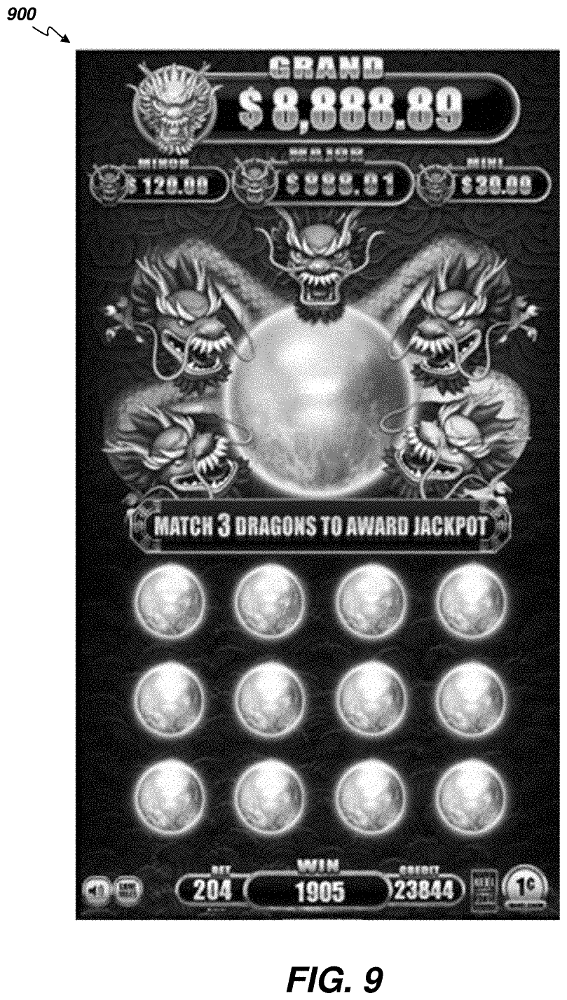

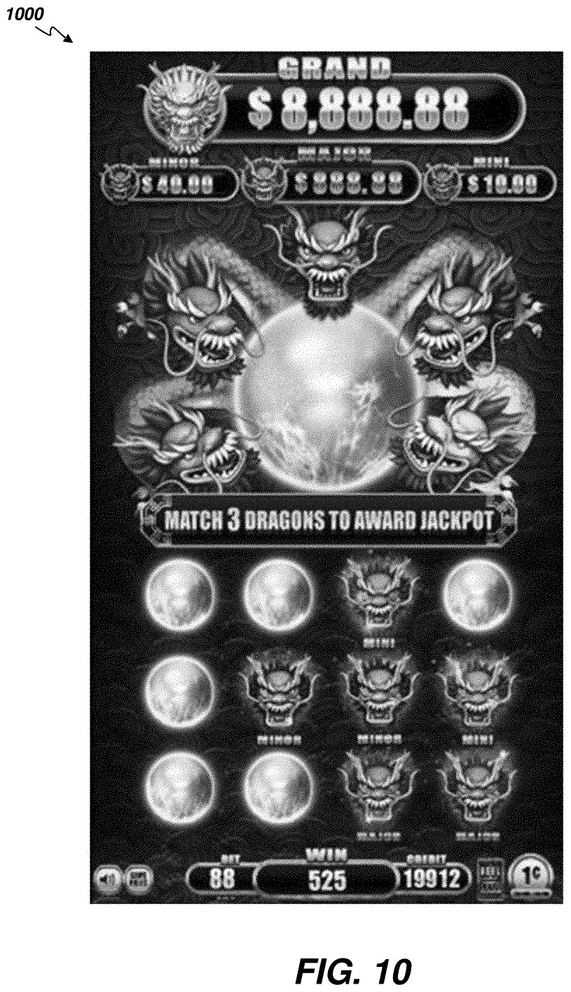

FIGS. 9-10 are figures of an example jackpot feature that can be triggered via the base game or free games bonus feature. In certain embodiments, this occurs whenever one or more WILDS (or other selected symbols) land on the screen. In this example embodiment, the jackpot feature is a “Pick 3” jackpot feature, but other jackpot features could be used. In the example “Pick 3” jackpot feature, users touch certain graphical user interface symbols (e.g., in the illustrated example, orbs) until they match 3 symbols corresponding to a designated target set of symbols. In the illustrated embodiment, the target symbols (shown as colored dragons) correspond to the GRAND, MAJOR, MINOR or MINI jackpots. It should be understood that different numbers of available jackpots can be provided with different respective progressive or value levels, respectively. In the illustrated embodiment, the GRAND and MAJOR jackpots are progressive jackpots, whereas the MINOR and MINI are credit prizes that scale with bet multiplier and denomination played. Of course, this is by way of example only, and other target symbols (or other mappings) can be used.

### III.B. Balancing Trigger Rate for Entering Jackpot Bonus Feature

To ensure the same RTP for each multi-gate option a user could potentially select, the rate that an RNG call triggers the jackpot bonus feature varies accordingly. If each multi-gate option was not the same, because of regulations the game would need to disclose the optimal solution to the user. The multi-gate option allows a user to select a volatility. Generally, as the number of spins a user selects for the free game bonus feature decreases, the rate to trigger the jackpot bonus game feature after landing on one or more WILDS increases. Additionally, as the probability of landing a WILD because of the reel size increases, then the chances of triggering the jackpot bonus feature after landing on one or more WILDs decrease. Thus, in particular embodiments, the rate to trigger the jackpot bonus game feature (e.g., “value X”) is determined by the following two factors: (1) the probability of landing a WILD (increased reel size increase the probability) and (2) the number of free spins. Other implementations could utilize additional or alternative factors to trigger the jackpot bonus game feature depending on the number and/or types of multi-gate features.

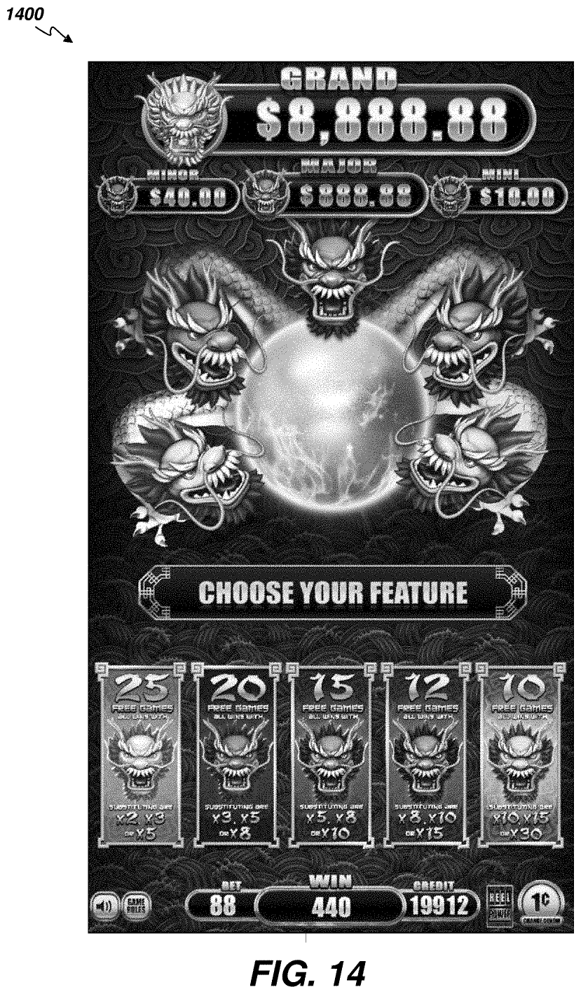

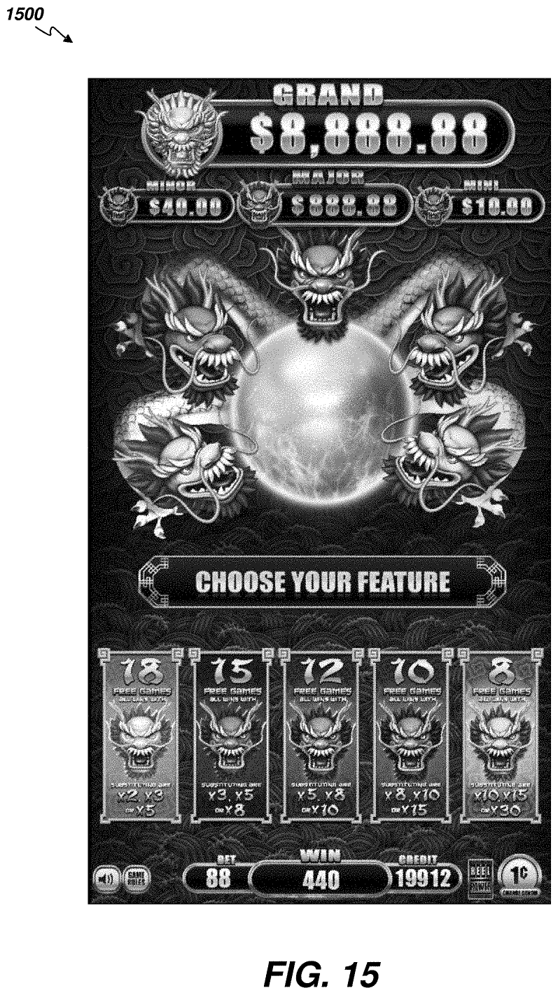

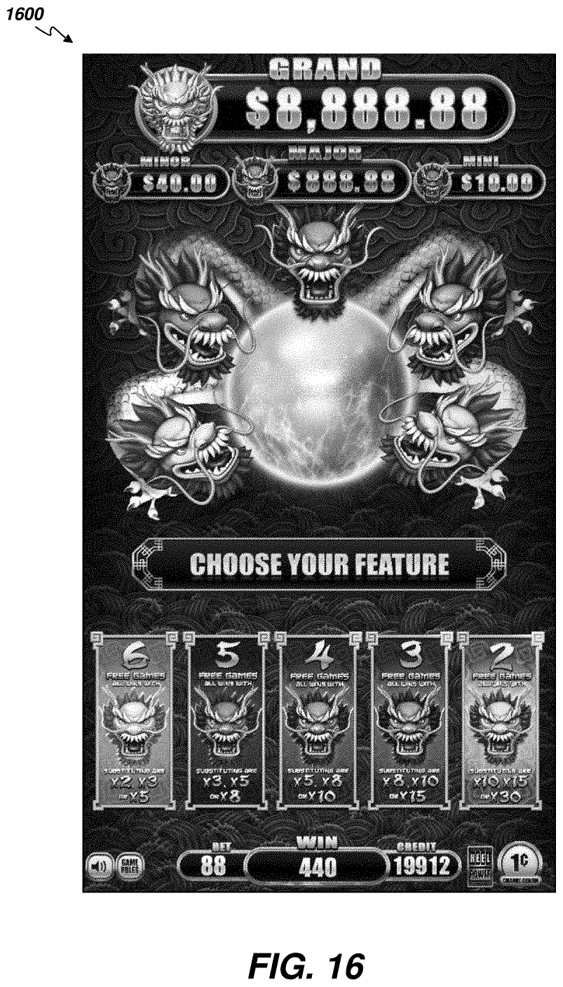

Still further, in the illustrated implementation, the number of free spins is dependent on the reel size and dragon color attributes. Variations to the free spins are illustrated in screen shots 1400, 1500, and 1600 of FIGS. 14-16, respectively. The rate to trigger the jackpot bonus game feature (e.g., “value X”) can also factor retrigger situations.

### III.C. Hybrid Credit/Bet Multiplier Selection

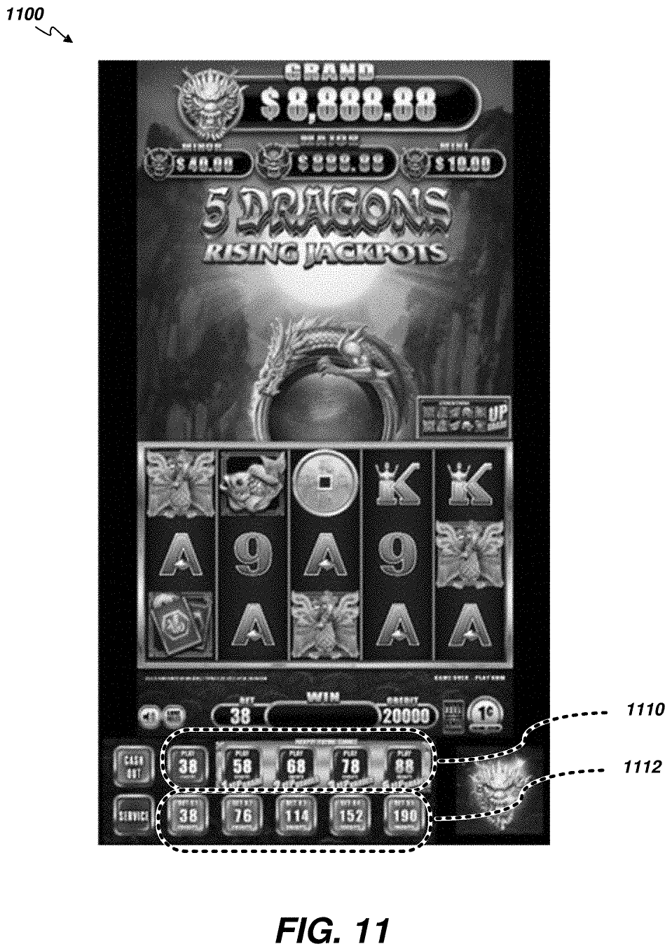

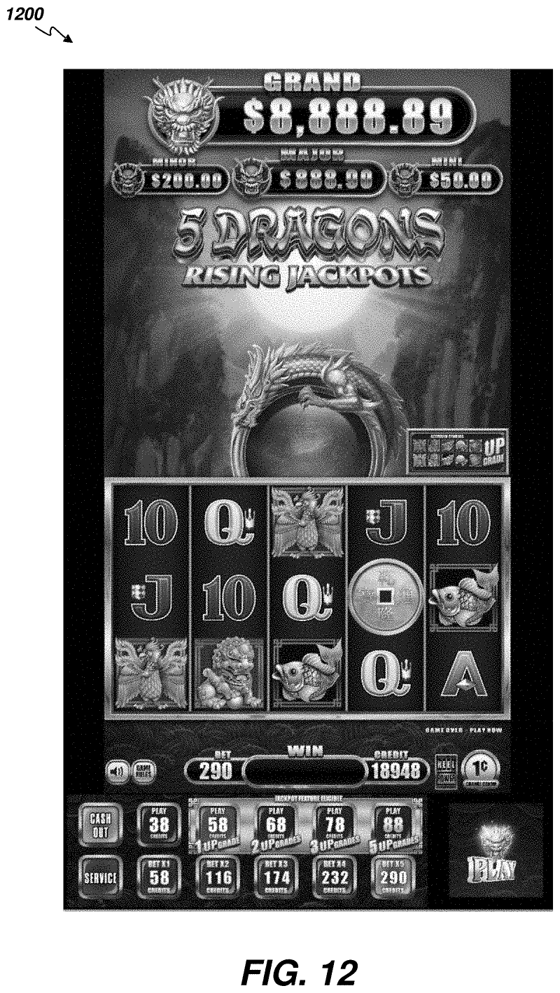

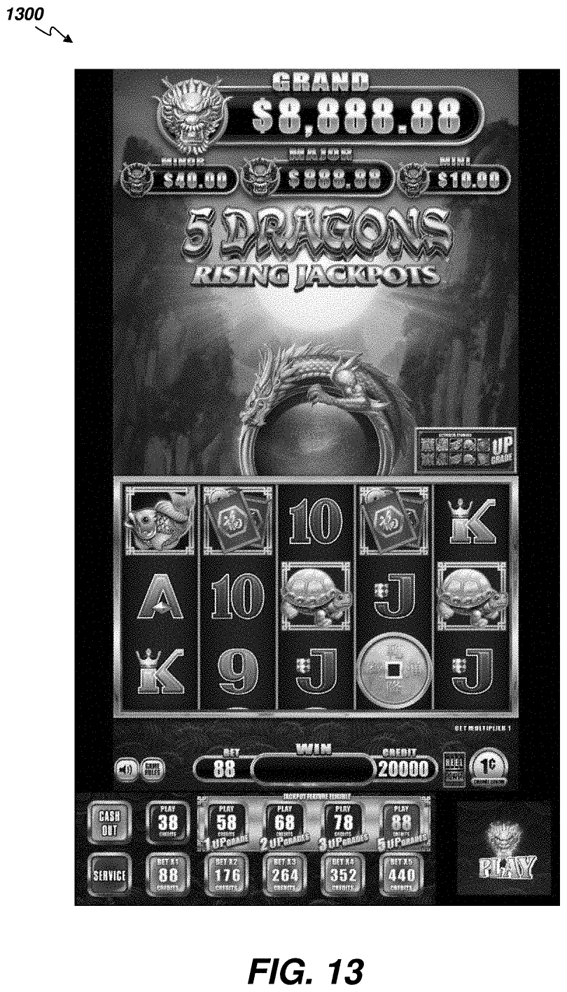

In certain embodiments, the button deck includes credit buttons (top row) and multiplier buttons (bottom row). In accordance with certain embodiments, the game can use a hybrid approach to provide additional value when a user increases his or her bet. As shown in screen shot 1100 of FIG. 11, the top row (shown at 1110) has 5 credit buttons: 38, 58, 68, 78, and 88 credits. The bottom row (shown at 1112) includes a ×1, ×2, ×3, and ×5 multiplier. When a user scales up the credits (e.g., 58 credits (as shown in screen shot 1200 of FIG. 12) or 88 credits (as shown in screen shot 1300 of FIG. 13), this can scale up the rate the jackpot bonus feature will hit. For example, the jackpot bonus feature can hit on average 1 out 800 spins from base game for the 58 credits vs. 1 out of 500 spins from base game for the 88 credits. In this example, increasing the bet multipliers (bottom row) also increases one or more of the jackpot amounts. For example, in particular embodiments, the nonprogressive jackpot awards (here, the MINOR and MINI credit prizes) scale with the bet multiplier.

This functionality allows for the RTP for the jackpot bonus feature to remain constant (or substantially constant) across multiple credit/bet multiplier selections. In other words, to maintain a specific RTP, the relative size of one or more nonprogressive jackpot awards (here, the MINI and MINOR jackpots) is scaled rather than altering the hit rate for the bonus multiplier for the one or more available progressive jackpot awards. Generally speaking, if the one or more nonprogressive jackpots do not scale with the bet multiplier, there may be little or no difference in the nonprogressive amount when compared to the actual bet amount. This results in a less volatile game that generates more opportunities to trigger the jackpot bonus feature that have relatively smaller awards. By scaling the nonprogressive jackpot awards, the game volatility increases such that there are less opportunities to trigger the jackpot bonus feature, but when triggered, the jackpot bonus feature provides relatively larger awards, while maintaining a desired RTP.

In example embodiments of the jackpot bonus feature, the odds of winning the nonprogressive jackpot awards (here, the MINI and MINOR) are generally higher than other jackpot award. Thus, for example, in a case where a nonprogressive jackpot award is at a particular level (e.g., the MINI is $6), and a user increases his/her bet with a 5× multiplier from $0.88 to $4.40, In a non-scaled environment, if a player is betting $4.40 but wins the example nonprogresive jackpot (e.g., the MINI jackpot at $6), then the difference between the two is relatively minor. However, if the nonprogressive awards are scaled, then the example progressive jackpot would be increased to $30. This scaling of the nonprogressive awards in relation to the jackpot bonus feature trigger rate helps the overall game achieve a constant or substantially constant RTP required in many jurisdictions regulatory requirements.

### III.D. Overall Example Embodiments

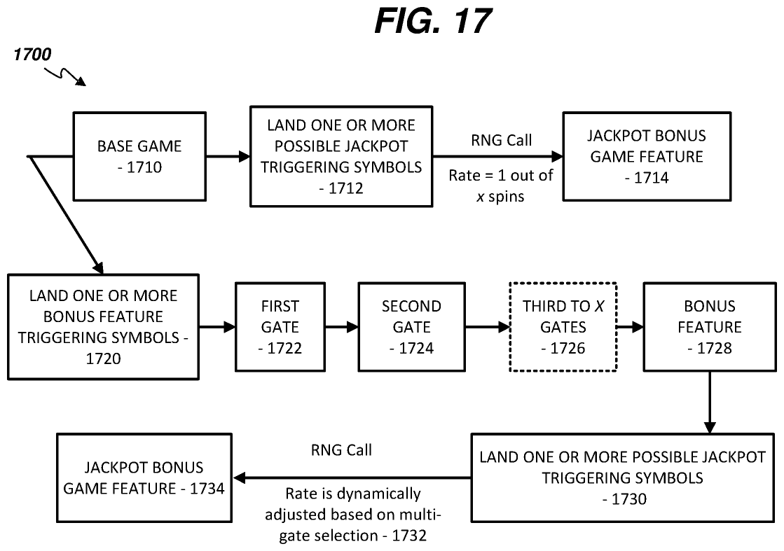

FIG. 17 is a flowchart 1700 showing an overall example process flow for triggering a jackpot bonus game feature in accordance with the disclosed technology. The method of FIG. 17 can be performed by a game controller of the EGM or an EGM server in communication with an EGM. Although the illustrated method is described in a particular, sequential order, it should be understood that this manner of description encompasses rearrangement. For example, operations described sequentially may in some cases be rearranged or performed concurrently.

At 1710, a base game is initiated and an outcome is determined (e.g., using the gaming RNG 318 of the gaming engine 316). In the example embodiment, if the outcome of the base game results in one or more possible jackpot triggering symbols (shown at 1712), then a possibility for a jackpot bonus game feature is triggered. The jackpot triggering symbols can be any symbol, such as a WILD symbol. The determination can be made using an RNG (such as the gaming RNG 318), which in the illustrated embodiment is at a rate of 1 to x, where x can be any integer value. If the trigger is achieved, then a jackpot bonus game feature is activated at 1714. Procedures 1712 and 1714 represent a first path to the jackpot bonus game feature.

In the example embodiment, if the outcome of the base game results in one or more bonus feature triggering symbols (shown at 420), then two or more feature gates are initiated. The bonus feature triggering symbols can be any symbols and may be one or more “scatter” symbols that appear in the game grid. In the illustrated embodiment, the multi-gate process includes a first gate 1722, a second gate 1724, and optionally a third, fourth, or further gate 1726. The gates can be any suitable gate as described. Still further, selections from any one of the gates can influence and cause a particular configuration of a “downstream” gate (e.g., alterations in the available selections for any one or more of those downstream gates).

At 1728, a bonus feature is activated. The bonus feature can be any suitable bonus feature (such as a free game bonus feature as disclosed herein activated). As explained herein, the two or more gates can be used to configure the bonus feature (e.g., in terms of one or more of reel strips, number of free games, etc.).

In the illustrated embodiment, and as shown at 1730, if one or more possible jackpot triggering symbols land as a result of the bonus feature (e.g., one or more WILD symbols), then a possibility for a jackpot bonus game feature is triggered. The determination can be made using an RNG, which in the illustrated embodiment is dynamically adjusted based on the multi-gate selection (as shown at 1732). The rate can be any of 1 to x, where x can be any integer value but is dependent on the outcome of the selections from the multiple gates. If the trigger is achieved, then a jackpot bonus game feature is activated at 1734.

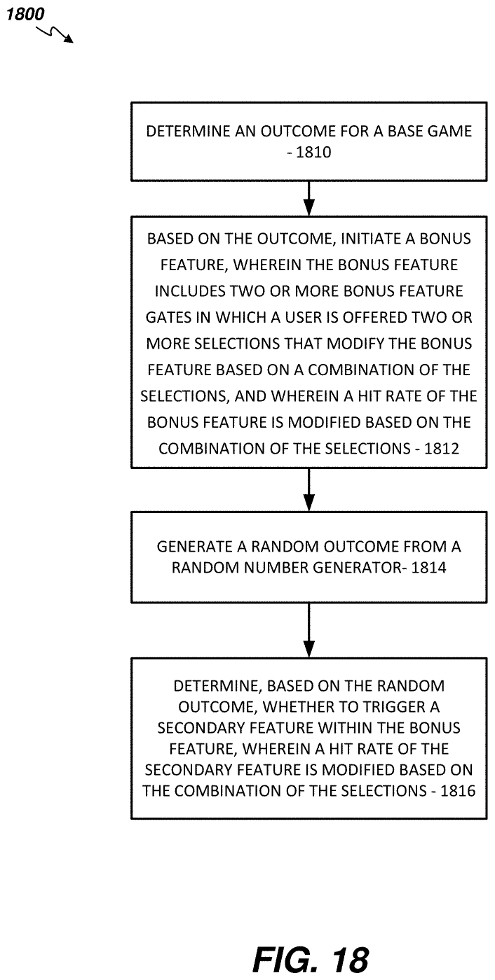

Procedures 1720-1734 represent a second path to the jackpot bonus game feature. Further, and in accordance with particular embodiments of the disclosed technology, the overall hit rate of the jackpot bonus game feature via procedures 1720-1730 is configured to be constant (or substantially constant) so that the RTP of the game is not substantially altered by any particular selection made by the user during the multi-gate selection process (here, gates 1722-1726). For example, this can be accomplished through the dynamic adjustments made at 1732, which may be in the form of altering the jackpot bonus game feature hit rate for any particular post-gates configuration. FIG. 18 is a flow chart 1800 illustrating an example embodiment for controlling an electronic gaming machine (“EGM”). In particular, the method of FIG. 11 can be performed by a game controller of the EGM or an EGM server in communication with an EGM. Although the illustrated method is described in a particular, sequential order, it should be understood that this manner of description encompasses rearrangement. For example, operations described sequentially may in some cases be rearranged or performed concurrently.

At 1810, an outcome for a base game is determined.

At 1812, based on the outcome from 1810, a bonus feature is initiated. In the illustrated embodiment, the bonus feature includes two or more bonus feature gates in which a user is offered two or more selections that modify the bonus feature based on a combination of the selections, and a hit rate of the bonus feature is modified based on the combination of the selections.

At 1814, a random outcome is generated from a random number generator.

At 1816, based on the random outcome, a determination is made as to whether to trigger a secondary feature within the bonus feature, wherein a hit rate of the secondary feature is modified based on the combination of the selections.

In certain example implementations, the bonus feature is caused to be performed based on the combination of the selections. Still further, in some embodiments, a jackpot bonus game feature is caused to be performed based on a jackpot-winning result from the bonus feature as modified by the selections. In such implementations, a rate of achieving a progressive jackpot-winning result can be altered depending on the combination of the selections. In further implementations, an amount of a nonprogressive jackpot-winning result can be altered depending on the combination of the selections.

In some implementations, one or more of the paytable, number of reels, size of the reels, or reel strips of the bonus feature are modified based on the combination of the selections. In further implementations, at least two of the bonus features as modified by the combination of the selections provide a constant or substantially constant return to player (“RTP”). In certain implementations, one of the two or more bonus feature gates presents the user a choice of two or more different reel sizes. In some implementations, one of the two or more bonus feature gates presents the user a choice of a multiplier range. In further implementations, a multiplier applied during the bonus feature is randomly selected from a selected multiplier range. In further implementations, a first of the bonus feature gates presents the user a choice of multiple different ranges of a first bonus feature characteristic, and, in a second of the bonus feature gates presents the user a choice of multiple different ranges of a second bonus feature characteristic, the multiple different ranges of the second bonus feature characteristics being dependent on and varied by the user's selection from the first of the bonus feature gates. In some implementations, each of the multiple different ranges of the second bonus feature characteristic are associated with a respective one of the first bonus feature characteristics from within the selected range of the first of the bonus feature gates.

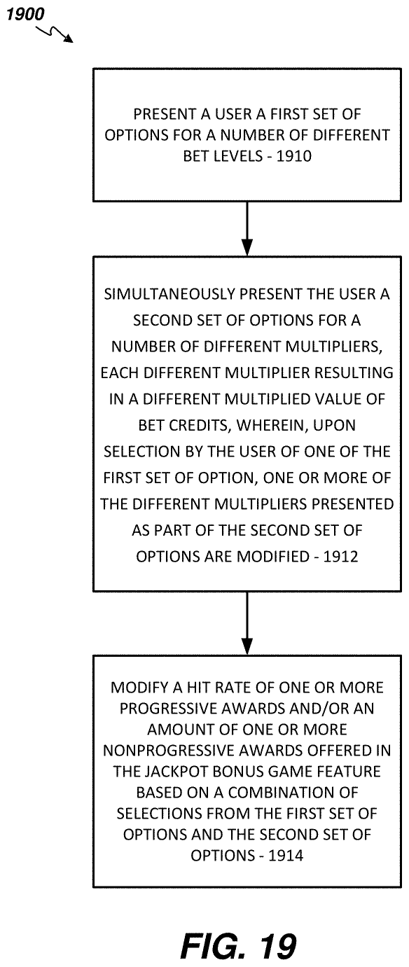

FIG. 19 is a flow chart 1900 illustrating an example embodiment for controlling an EGM. In particular, the method of FIG. 19 can be performed by a game controller of the EGM or an EGM server in communication with an EGM. Although the illustrated method is described in a particular, sequential order, it should be understood that this manner of description encompasses rearrangement. For example, operations described sequentially may in some cases be rearranged or performed concurrently. In the illustrated embodiment, the method is performed as part of a base game or game feature in which a jackpot bonus game feature is available

At 1910, a user is presented a first set of options for a number of different bet levels

At 1912, the user is simultaneously presented a second set of options for a number of different multipliers, each different multiplier resulting in a different multiplied value of bet credits. In certain implementations, upon selection by the user of one of the first set of option, one or more of the different multipliers presented as part of the second set of options are modified.

At 1914, a hit rate of one or more progressive awards and/or an amount of one or more nonprogressive awards offered in the jackpot bonus game feature is modified based on a combination of selections from the first set of options and the second set of options.

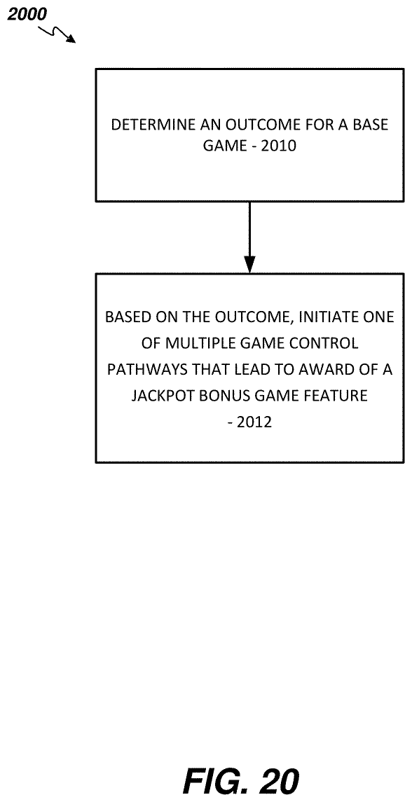

FIG. 20 is a flow chart 2000 illustrating another example embodiment for controlling an EGM. In particular, the method of FIG. 20 can be performed by a game controller of the EGM or an EGM server in communication with an EGM. Although the illustrated method is described in a particular, sequential order, it should be understood that this manner of description encompasses rearrangement. For example, operations described sequentially may in some cases be rearranged or performed concurrently. In the illustrated embodiment, the method is performed as part of a base game or game feature in which a jackpot bonus game feature is available

At 2010, an outcome for a base game is determined

Based on the outcome, and at 2012, one of multiple game control pathways that lead to award of a jackpot bonus game feature is initiated.

In some implementations, one of the multiple game control pathways includes two or more bonus game feature gates. In certain implementations, in at least one of the bonus game feature gates, the user can select one or more of a reel strip size, a number of free spins, or a multiplier. In particular implementations, in at least one of the bonus game feature gates, the user can select one or more of a range of reel strip sizes, a range of a number of free spins, or a range of a multiplier. In some implementations, a first of the bonus feature gates presents the user a choice of multiple different ranges of a first bonus feature characteristic, and a second of the bonus feature gates presents the user a choice of multiple different ranges of a second bonus feature characteristic, the multiple different ranges of the second bonus feature characteristics being dependent on and varied by the user's selection from the first of the bonus feature gates. In some implementations, selections from the two or more bonus game feature gates cause the bonus feature to be modified to provide a constant or substantially constant return to player (“RTP”). In certain implementations, selections from the two or more bonus game feature gates cause the bonus feature to be modified to provide different rates for awarding a jackpot feature.

### III.E. Other Example Implementations

For the embodiments described above, the overall rate to hit the jackpot bonus for any multi-gate selection process is the same since the payout for jackpot bonus remains substantially the same. If the overall rate to hit the jackpot bonus feature within the free game bonus feature changes because of the multi-gate selection, then the payout of the jackpot bonus feature can be adjusted. For example, if one multi-gate option produces an overall rate to hit the jackpot bonus feature of 1 out of 1500 spins and another overall rate to the jackpot bonus feature is 1 out of 800, then the payout would be decreased for the 1 out of 800 jackpot bonus feature to ensure the same overall RTP for the game.

Additionally, in the free spin bonus game, the pay tables of the jackpot bonus game could increase based on the number of WILD symbols that land. If multiple WILDS land, the jackpot bonus game would have a higher pay table than if a single WILD lands. The rate to trigger the jackpot bonus game feature after landing on the WILDs (e.g., “value X”) would need to be adjusted because of the different pay tables.

In one or more implementations, the secondary jackpot bonus feature can also trigger a third bonus feature. If this occurs, the rate to trigger the jackpot bonus game feature can be changed to account for being triggered in a third bonus feature that is embedded in the secondary jackpot bonus feature.

Additionally, in some instances, the multi-gate features can include multiple mystery prizes that randomly set the number of free games, slot grid size, and dragon color. If this occurs, the rate to trigger the jackpot bonus game feature after landing on the WILDs (e.g., “value X”) can be modified according to all the combinations of the mystery prizes. For example, an RNG (such as RNG 318) can be used to determine the grid size and/or free games. Recall that the rate to trigger the jackpot bonus game feature is determined by the following two factors: (1) the probability of landing a WILD (increased reel size increase the probability) and (2) the number of free spins. Based on the mystery selections and to provide substantially the same RTP, specific lookup tables for each possible mystery selection can be used to address the variations in the rate of triggering the jackpot bonus game feature resulting from the mystery selection. As an example, if the mystery selections result in a relatively large reel size (e.g., 6×5 grid) and a relatively large number of free spins (e.g., 25 free spins) a lookup table could be configured such that the rate of triggering the jackpot bonus game feature could be relatively low (e.g., 1 out of 1500 spins). In another example, if the mystery selections result in a relatively small reel size (e.g., 3×5) and a relatively small number of free spins (e.g., 2 free spins), the jackpot bonus game feature could be triggered at a relatively high rate (e.g., 1 out of 30 spins).

### IV. Alternatives, Variations, and Conclusion

Numerous embodiments are described in this disclosure, and are presented for illustrative purposes only. The described embodiments are not, and are not intended to be, limiting in any sense. The present disclosure is widely applicable to numerous embodiments, as is readily apparent from the disclosure. One of ordinary skill in the art will recognize that the innovations described herein may be practiced with various modifications and alterations, such as structural, logical, software, and electrical modifications. Although particular features of the innovations described herein may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the innovations described herein that must be present in all embodiments.

The Title (set forth at the beginning of the first page of this disclosure) is not to be taken as limiting in any way as the scope of the disclosed embodiments.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget.” Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget”” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When introducing elements of aspects of the present disclosure or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

When a single device, component, structure, or article is described herein, more than one device, component, structure or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component, structure, or article is described herein (whether or not they cooperate), a single device, component, structure, or article may alternatively be used in place of the more than one device, component, structure, or article that is described. For example, a plurality of computer-based devices may be substituted with a single computer-based device. Accordingly, the various functionality that is described as being possessed by more than one device, component, structure, or article may alternatively be possessed by a single device, component, structure, or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Further, the systems and methods described herein are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the innovations described herein. Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the innovations described herein, and does not imply that the illustrated process is preferred.

Although a process may be described as including a plurality of steps, that does not indicate that all or even any of the steps are essential or required. Various other embodiments within the scope of the present disclosure include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the present disclosure include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

For the sake of presentation, the detailed description uses terms like “determine” and “select” to describe computer operations in a computer system. These terms denote operations performed by a computer, and should not be confused with acts performed by a human being. The actual computer operations corresponding to these terms vary depending on implementation. For example, “determining” something can be performed in a variety of manners, and therefore the term “determining” (and like terms) can indicate calculating, computing, deriving, looking up (e.g., in a table, database or data structure), ascertaining, recognizing, and the like.

As used herein, the term “send” denotes any way of conveying information from one component to another component, and the term “receive” denotes any way of getting information at one component from another component. The two components can be part of the same computer system or different computer systems. The information can be passed by value (e.g., as a parameter of a message or function call) or passed by reference (e.g., in a buffer). Depending on context, the information can be communicated directly between the two components or be conveyed through one or more intermediate components. As used herein, the term “connected” denotes an operable communication link between two components, which can be part of the same computer system or different computer systems. The operable communication link can be a wired or wireless network connection, which can be direct or pass through one or more intermediate components (e.g., of a network). Communication among computers and devices may be encrypted to insure privacy and prevent fraud in any of a variety of ways well known in the art.

It will be readily apparent that the various methods and algorithms described herein may be implemented by, e.g., appropriately programmed general-purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium for performing the process. The apparatus that performs the process can include components and devices (e.g., a processor, input and output devices) appropriate to perform the process. A computer-readable medium can store program elements appropriate to perform the method.

The term “computer-readable medium” refers to any non-transitory storage or memory that may store computer-executable instructions or other data in a computer system and be read by a processor in the computer system. A computer-readable medium may take many forms, including but not limited to non-volatile storage or memory (such as optical or magnetic disk media, a solid-state drive, a flash drive, PROM, EPROM, and other persistent memory) and volatile memory (such as DRAM). The term “computer-readable media” excludes signals, waves, and wave forms or other intangible or transitory media that may nevertheless be readable by a computer.

The present disclosure provides, to one of ordinary skill in the art, an enabling description of several embodiments and/or innovations. Some of these embodiments and/or innovations may not be claimed in the present application, but may nevertheless be claimed in one or more continuing applications that claim the benefit of priority of the present application. Applicants may file additional applications to pursue patents for subject matter that has been disclosed and enabled but not claimed in the present application.

The foregoing description discloses only exemplary embodiments of the present disclosure. Modifications of the above disclosed apparatus and methods which fall within the scope of the present disclosure will be readily apparent to those of ordinary skill in the art. For example, although the examples discussed above are illustrated for a gaming market, embodiments of the present disclosure can be implemented for other markets. The gaming system environment of the examples is not intended to suggest any limitation as to the scope of use or functionality of any aspect of the disclosure.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

What is claimed is:

1. A system comprising:
one or more processors;
memory, the memory having stored thereon computer-executable instructions for causing the one or more processors, when programmed thereby, to perform operations to control a gaming device, the operations comprising:
determining a random outcome for a base game;
based on the outcome, initiating a bonus feature, wherein the bonus feature includes two or more bonus feature gates in which a user is offered two or more selections that modify the bonus feature based on a combination of the selections;
generating a random outcome from a random number generator; and
determining, based on the random outcome, whether to trigger a secondary feature within the bonus feature, wherein a hit rate of the secondary feature is modified based on the combination of the selections.

2. The system of claim 1, wherein one or more of the pay table, number of reels, size of the reels, or reel strips of the bonus feature are modified based on the combination of the selections.

3. The system of claim 1, wherein at least two of the bonus features as modified by the combination of the selections provide a constant or substantially constant return to player (“RTP”).

4. The system of claim 1, wherein one of the two or more bonus feature gates presents the user a choice of two or more different reel sizes.

5. The system of claim 1, wherein one of the two or more bonus feature gates presents the user a choice of a multiplier range.

6. The system of claim 5, wherein a multiplier applied during the bonus feature is randomly selected from a selected multiplier range.

7. The system of claim 1, wherein a first of the bonus feature gates presents the user a choice of multiple different ranges of a first bonus feature characteristic, and
wherein a second of the bonus feature gates presents the user a choice of multiple different ranges of a second bonus feature characteristic, the multiple different ranges of the second bonus feature characteristics being dependent on and varied by the user's selection from the first of the bonus feature gates.

8. The system of claim 7, wherein each of the multiple different ranges of the second bonus feature characteristic are associated with a respective one of the first bonus feature characteristics from within the selected range of the first of the bonus feature gates.

9. The system of claim 1, wherein the operations further comprise:
causing the bonus feature to be performed based on the combination of the selections; and
causing a jackpot bonus game feature to be performed based on a jackpot-winning result from the bonus feature as modified by the selections.

10. The system of claim 9, wherein a rate of achieving a progressive jackpot-winning result is altered depending on the combination of the selections.

11. The system of claim 9, wherein an amount of a nonprogressive jackpot-winning result is altered depending on the combination of the selections.

12. A system comprising:
one or more processors;
memory; and
control logic, implemented using the one or more processors and memory, configured to control a user interface of an electronic gaming machine (“EGM”), the operations comprising:
as part of a base game or game feature in which a jackpot bonus game feature is available:
presenting a user a first set of options for a number of different bet levels;
simultaneously presenting the user a second set of options for a number of different multipliers, each different multiplier resulting in a different multiplied value of bet credits,
wherein, upon selection by the user of one of the first set of option, one or more of the different multipliers presented as part of the second set of options are modified.

13. The system of claim 12, wherein the operations further comprise modifying a hit rate of one or more progressive awards and/or an amount of one or more nonprogressive awards offered in the jackpot bonus game feature based on a combination of selections from the first set of options and the second set of options.

14. A method for controlling an electronic gaming machine (“EGM”), comprising:
determining an outcome for a base game; and
based on the outcome, initiating one of multiple game control pathways that lead to award of a jackpot bonus feature,
wherein one of the multiple game control pathways includes two or more bonus feature gates, and wherein selections from the two or more bonus feature gates cause the bonus feature to be modified to provide different rates for awarding a jackpot feature.

15. The method of claim 14, wherein in at least one of the bonus feature gates, the user can select one or more of a reel strip size, a number of free spins, or a multiplier.

16. The method of claim 14, wherein, in at least one of the bonus feature gates, the user can select one or more of a range of reel strip sizes, a range of a number of free spins, or a range of a multiplier.

17. The method of claim 16, wherein a first of the bonus feature gates presents the user a choice of multiple different ranges of a first bonus feature characteristic.

18. The method of claim 17, wherein a second of the bonus feature gates presents the user a choice of multiple different ranges of a second bonus feature characteristic, the multiple different ranges of the second bonus feature characteristics being dependent on and varied by the user's selection from the first of the bonus feature gates.

19. The method of claim 14, wherein selections from the two or more bonus feature gates cause the bonus feature to be modified to provide a constant or substantially constant return to player (“RTP”).

20. The method of claim 14, wherein one of the two or more bonus feature gates presents the user a choice of a multiplier range, and wherein a multiplier applied during the bonus feature is randomly selected from a selected multiplier range.
